(19) United States
(12) Patent Application Publication
(10) Pub. No.: US 2024/0158095 A1
(43) Pub. Date: May 16, 2024

(54) AIRCRAFT COMPRISING A HYDROGEN GAS SUPPLY SYSTEM

(71) Applicant: Airbus Operations SAS, TOULOUSE (FR)

(72) Inventor: Jérôme MILLIERE, TOULOUSE (FR)

(21) Appl. No.: 18/507,556

(22) Filed: Nov. 13, 2023

(30) Foreign Application Priority Data
Nov. 15, 2022 (FR) 2211878

(51) Int. Cl. B64D 37/30; B64D 37/00; B64D 37/34

(52) U.S. Cl. CPC B64D 37/30; B64D 37/005; B64D 37/34

(57) ABSTRACT

An aircraft including a supply system including a hydrogen gas tank, a recipient device that consumes hydrogen gas, a feed line between the tank and the recipient device, a first enclosure in which are installed a heating system configured to heat the hydrogen gas, a second enclosure in which are installed a drive system configured to drive the hydrogen gas towards the recipient device, a safety tank for a pressurized inert fluid, and a purge line between a free section of the feed line and a distribution system. If a leak is detected, the pressurized inert fluid is pushed into the purge line to evacuate the hydrogen gas from the free section. With such a supply system, the hydrogen gas present in a free section is evacuated in case of leakage.

### CROSS-REFERENCES TO RELATED APPLICATIONS

This application claims the benefit of the French patent application No. 2211878 filed on Nov. 15, 2022, the entire disclosures of which are incorporated herein by way of reference.

### FIELD OF THE INVENTION

The present invention relates to an aircraft comprising a hydrogen gas supply system with improved safety. The present invention also relates to a purge method used with such a supply system.

### BACKGROUND OF THE INVENTION

In order to reduce the pollution caused by the use of kerosene in the operation of aircraft, some aircraft have been developed with engines that are supplied with hydrogen gas, either for supplying a fuel cell to generate an electric current which in turn drives the aircraft engine, or for directly supplying the combustion chamber of a combustion engine of the aircraft.

FIG. 4 shows a prior art supply system 400 which comprises a hydrogen gas tank 402 and at least one recipient device 404, which is designed to consume the hydrogen gas that it receives, and which may be, for example, a fuel cell or a combustion engine.

The supply system 400 also comprises, for each recipient device 404, a feed line 406 extending between the hydrogen gas tank 402 and the recipient device 404. The feed line 406 is conventionally a double-walled line.

Upstream of the recipient device 404, and for each feed line 406, there is provided a heating system 414 comprising a heat exchanger 416 mounted on the feed line 406 upstream of the recipient device 404, and a solenoid flow control valve 418 which, in this case, is adjustable and is mounted on the feed line 406 upstream of the heat exchanger 416.

The supply system 400 comprises a first solenoid shut off valve 420 which is mounted on the feed line 406 upstream of the solenoid flow control valve 418.

When the hydrogen gas reaches the heating system 414, it is heated before reaching the recipient device 404.

Downstream of the tank 402, and for each feed line 406, there is provided a drive system 408 comprising a pump 410 mounted on the feed line 406 downstream of the tank 402.

The supply system 400 comprises a second solenoid shut off valve 412 which is mounted on the feed line 406 downstream of the pump 410. The hydrogen gas is thus trapped in the tank 402 and driven towards the recipient device 404 by the drive system 408.

In order to confine the hydrogen gas, in case of leakage in the various components of the heating system 414, the supply system 400 comprises, for each feed line 406, a first enclosure 422 through which the feed line 406 passes in a sealed manner and in which are installed the heat exchanger 416, the solenoid flow control valve 418 and the first solenoid shut off valve 420. Thus, in case of leakage in the heating system 414, the hydrogen gas remains confined and may be evacuated to the outside by any appropriate evacuation system, such as an evacuation pipe 424 which has one end opening into the first enclosure and a second end opening on the outside of the aircraft.

In order to confine the hydrogen gas, in case of leakage in the various components of the drive system 408, the supply system 400 comprises, for each feed line 406, a second enclosure 426, through which the feed line 406 passes in a sealed manner, and in which are installed the pump 410 and the second solenoid shut off valve 412. Thus, in case of leakage in the drive system 408, the hydrogen gas remains confined and may be evacuated to the outside by any appropriate evacuation system, such as that described for the first enclosure 422.

Each feed line 406 comprises a free section 406a which extends outside the enclosures 422 and 426, between the associated first solenoid shut off valve 420 and second solenoid shut off valve 412. To limit the risks of leakage in the feed line 406, the latter takes the form of a double-walled line.

The safety of a supply system 400 may be further improved, particularly in the free section 406a of the feed line 406, which may be relatively long.

### SUMMARY OF THE INVENTION

An object of the present invention is to propose an aircraft comprising a hydrogen gas supply system having improved safety in case of leakage.

For this purpose, an aircraft is proposed, having a supply system comprising:
a hydrogen gas tank,
at least one recipient device designed to consume hydrogen gas,
for each recipient device, a double-walled feed line which fluidly connects the hydrogen gas tank and the recipient device,
for each feed line and upstream of the recipient device, a first enclosure, through which the feed line passes in a sealed manner, and in which first means, which may be in the form of a heating system, configured to heat the hydrogen gas, are installed on the feed line,
for each feed line, a first solenoid shut off valve mounted on the feed line upstream of the first means and installed in the first enclosure,
for each feed line and downstream of the tank, a second enclosure, through which the feed line passes in a sealed manner, and in which second means, which may be in the form of a drive system, arranged to capture the hydrogen gas in the tank and drive it towards the recipient device, are installed on the feed line,
for each feed line, a second solenoid shut off valve, mounted on the feed line downstream of the second means and installed in the second enclosure, where a free section of the feed line extends outside the first enclosure and the second enclosure, between the first solenoid shut off valve and the second solenoid shut off valve,
for each first enclosure, a supplementary evacuation pipe, a branch line fluidly connected between the feed line and the supplementary evacuation pipe which opens to the outside of the aircraft, and a third solenoid valve mounted on the branch line,
at least one safety tank containing a pressurized inert fluid,
for each free section, a purge line fluidly connected to the corresponding feed line downstream of the second solenoid shut off valve,
a distribution system fluidly connected between the at least one safety tank and each purge line, comprising an arrangement configured to direct the inert fluid towards one or other of the feed lines from one or other of the safety tanks,
for each purge line, a non-return valve mounted on the purge line, to allow the passage of a fluid from the distribution system towards the feed line and to prevent the passage of a fluid from the feed line towards the distribution system,
for each free section, at least one sensor arranged to detect a leak of hydrogen gas in the free section,
a control unit designed to receive information from each sensor relating to the detection or non-detection of a leak, so that, when no information relating to a leak is received, it causes the activation of the second means, the opening of each first solenoid shut off valve and each second solenoid shut off valve, and the closure of each third solenoid valve and the distribution system to prevent the flow of an inert fluid, and so that, when information relating to a leak in a free section is received, it causes the stopping of the second means corresponding to the free section, the closure of the first solenoid shut off valve and of the second solenoid shut off valve corresponding to the free section, and the opening of the third solenoid valve and the distribution system, so that the inert fluid flows towards the free section.

With such a supply system, the hydrogen gas present in a free section is evacuated in case of leakage.

Advantageously, the purge line is fluidly connected to the free section.

Advantageously, the branch line is fluidly connected to the free section.

Advantageously, the supply system comprises, for each first enclosure, an evacuation pipe which has one end opening into the first enclosure and a second end opening to the outside, and the associated supplementary evacuation pipe is fluidly connected to the evacuation pipe.

The invention also relates to a purge method implemented in an aircraft according to one of the above variants, wherein the purge method comprises, starting from a situation in which the control unit causes the activation of the second means, the opening of each first solenoid shut off valve and each second solenoid shut off valve, and the closure of each third solenoid valve and the distribution system so that the inert fluid does not flow:
a waiting step in which the control unit waits for information from at least one of the sensors informing it of the detection of a leak in a free section,
if such information is not received, a looping step in which the process loops back to the waiting step,
if such information is received, a stopping step in which the control unit causes the stopping of the second means corresponding to the free section where a leak has been detected,
a closing step in which the control unit causes the closure of the first solenoid shut off valve and the second solenoid shut off valve corresponding to the free section where a leak has been detected,
an opening step in which the control unit causes the opening of the third solenoid valve corresponding to the free section where a leak has been detected, and
a command step in which the control unit commands the distribution system so as to feed the inert fluid from a safety tank towards the free section where a leak has been detected.

According to a particular embodiment, the purge method comprises, between the stopping step and the command step:
a first closing step in which the control unit causes the closure of the second solenoid shut off valve corresponding to the free section where a leak has been detected,
an opening step in which the control unit causes the opening of the third solenoid valve corresponding to the free section where a leak has been detected, and
a second closing step in which the control unit causes the closure of the first solenoid shut off valve corresponding to the free section where a leak has been detected.

### BRIEF DESCRIPTION OF THE DRAWINGS

The abovementioned characteristics of the invention, along with others, will become more clearly apparent on reading the following description of an example of embodiment, the description being given with reference to the appended drawings, in which:

FIG. 1 is view from above of an aircraft according to the invention,

FIG. 2 is a schematic representation of a hydrogen gas supply system according to the invention,

FIG. 3 shows schematically a flow diagram implemented with the hydrogen gas supply system according to the invention, and

FIG. 4 is a schematic representation of a prior art hydrogen gas supply system, and

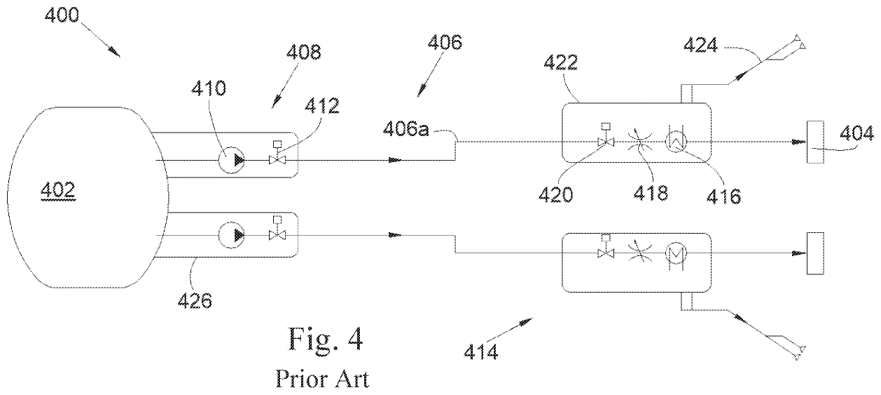

FIG. 5 shows schematically an example of the hardware architecture of a control unit used in the invention.

### DETAILED DESCRIPTION OF THE PREFERRED EMBODIMENTS

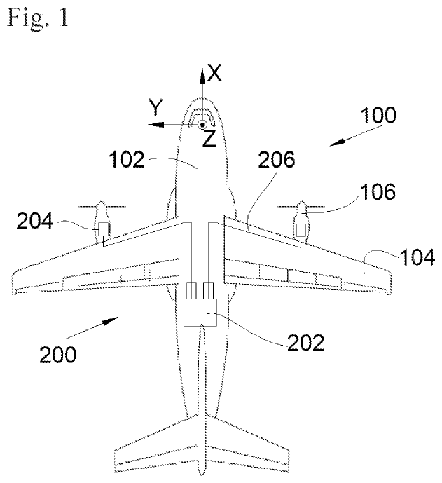

FIG. 1 shows an aircraft 100 comprising a fuselage 102 on each side of which is fixed a wing 104 which carries at least one engine 106, which in the embodiment of the invention presented here is a propeller engine.

The aircraft 100 also comprises a supply system 200 according to the invention, which comprises a hydrogen gas tank 202 and at least one recipient device 204 designed to consume the hydrogen gas that it receives. In the embodiment of the invention shown in FIG. 1, the recipient device 204 is a fuel cell which supplies electricity to the propeller engine, but in another embodiment the recipient device 204 may be the combustion chamber of a turbine engine.

For each recipient device 204, the supply system 200 comprises a feed line 206 which fluidly connects the hydrogen gas tank 202 and the recipient device 204. In the remainder of the description, the terms “upstream” and “downstream” relate to the direction of flow of the hydrogen gas in the feed line 206, that is to say from the hydrogen gas tank 202 towards the recipient device 204.

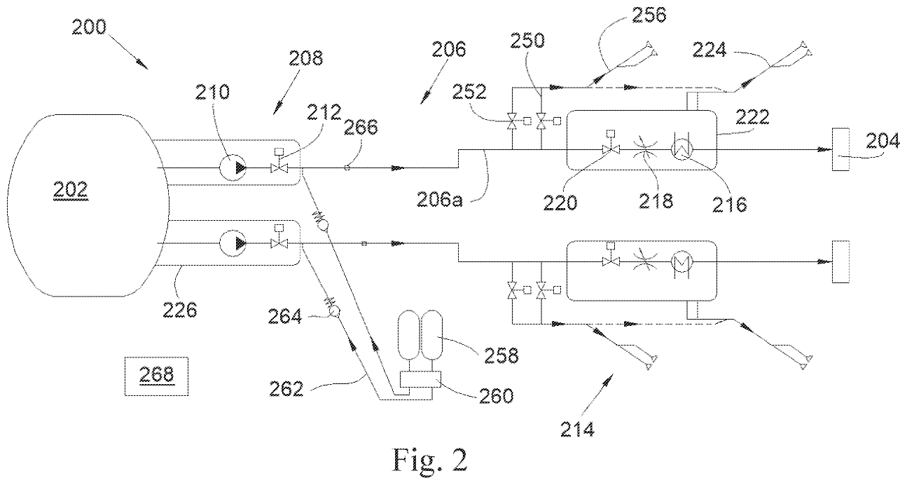

FIG. 2 shows the supply system 200.

The feed line 206 is a double-walled line; that is to say, it comprises an inner wall within which the hydrogen gas flows and an outer wall which is fixed around the inner wall and which is filled with an inert gas or evacuated or filled with a thermally insulating material.

Upstream of the recipient device 204, and for each feed line 206, a heating system 214 is provided, comprising first means which are installed on the feed line 206 and arranged to heat the hydrogen gas before sending it towards the recipient device 204.

In the embodiment of the invention presented here, the first means comprise a heat exchanger 216 mounted on the feed line 206 upstream of the recipient device 204, and a solenoid flow control valve 218 which in this case is adjustable and is mounted on the feed line 206 upstream of the heat exchanger 216.

The supply system 200 comprises a first solenoid shut off valve 220 which is mounted on the feed line 206 upstream of the first means, and in this case upstream of the solenoid flow control valve 218. The first solenoid shut off valve 220 causes or prevents the entry of the hydrogen gas into the heating system 214, depending on whether the valve is open or closed.

When the hydrogen gas reaches the heating system 214, it is heated before reaching the recipient device 204.

The heat exchanger 216 transfers heat to the hydrogen gas from a heat transfer fluid that flows in the heat exchanger 216.

Downstream of the tank 202, and for each feed line 206, a drive system 208 is provided, comprising second means that are arranged to capture the hydrogen gas in the tank 202 and to drive it towards the recipient device 204 through the feed line 206. In the embodiment of the invention presented in FIG. 2, the second means comprise a pump 210 mounted on the feed line 206 downstream of the tank 202.

The supply system 200 comprises a second solenoid shut off valve 212 which is mounted on the feed line 206 downstream of the second means, and in this case downstream of the pump 210. The second solenoid shut off valve 212 causes or prevents the exit of the hydrogen gas from the drive system 208, depending on whether the valve is open or closed.

In order to confine the hydrogen gas in case of leakage in the various components of the heating system 214, the supply system 200 comprises, for each feed line 206, a first enclosure 222, through which the feed line 206 passes in a sealed manner, and in which are installed the first means and the first solenoid shut off valve 220. Thus, in case of leakage in the heating system 214 or in the first solenoid shut off valve 220, the hydrogen gas remains confined and may be evacuated to the outside by any appropriate evacuation system, such as an evacuation pipe 224 which has one end opening into the first enclosure and a second end opening on the outside of the aircraft 100.

In order to confine the hydrogen gas in case of leakage in the various components of the drive system 208, the supply system 200 comprises, for each feed line 206, a second enclosure 226, through which the feed line 206 passes in a sealed manner, and in which are installed the second means and the second solenoid shut off valve 212. Thus, in case of leakage in the drive system 208 or in the second solenoid shut off valve 212, the hydrogen gas remains confined and may be evacuated to the outside by any appropriate evacuation system, such as that described for the first enclosure 222.

Each feed line 206 comprises a free section 206a which extends outside the first enclosure 222 and the second enclosure 226, between the first solenoid shut off valve 220 and the associated second solenoid shut off valve 212, and the hydrogen gas flows from the second solenoid shut off valve 212 towards the first solenoid shut off valve 220, which is downstream relative to the second solenoid shut off valve 212.

For each first enclosure 222, the supply system 200 comprises a branch line 250 which is fluidly connected, on the one hand, to the feed line 206 between the first solenoid shut off valve 220 and the second solenoid shut off valve 212, and, on the other hand, to a supplementary evacuation pipe 256 which has one end opening into the branch line 250 and a second end opening to the outside of the aircraft 100.

According to a particular embodiment, the supplementary evacuation pipe 256 associated with the branch line 250 and the evacuation pipe 225 associated with the first enclosure 222 are fluidly connected, as represented in broken lines. Such an arrangement enables the openings to the outside to be limited.

The branch line 250 is connected to the feed line 206 as closely as possible to the first solenoid shut off valve 220 and upstream of the latter, to limit the volume that is not purged, thus allowing the evacuation of the greater part of the hydrogen gas contained in the free section 206a, as explained below. The connection of the branch line 250 to the feed line 206 may be made inside or outside the first enclosure 222, that is to say in the free section 206a in this case.

In the embodiment of the invention shown in FIG. 2, in order to provide redundancy, there are two branch lines 250, which are combined before joining the evacuation pipe 256, 224.

Each branch line 250 is equipped with a third solenoid valve 252 which allows or prevents the passage of the hydrogen gas through the branch line 250.

The supply system 200 also comprises at least one safety tank 258 which contains a pressurized inert fluid such as gaseous helium.

In this case, there are two safety tanks 258, in order to provide redundancy and a sufficient quantity of inert fluid in case of any incident.

Each safety tank 258 is fluidly connected to a distribution system 260.

For each free section 206a, the supply system 200 also comprises a purge line 262, which is fluidly connected between the distribution system 260 and the feed line 206 downstream of the associated second solenoid shut off valve 212.

In the embodiment of the invention shown in FIG. 2, each purge line 262 is connected to the feed line 206 as closely as possible to the second solenoid shut off valve 212, to enable the inert fluid to flow through the greater part of the free section 206a, as explained below. The connection of the purge line 262 to the feed line 206 may be made inside or outside the second enclosure 226, that is to say in the free section 206a in this case.

The distribution system 260 comprises means for directing the inert fluid towards one or other of the feed lines 206 as required, and towards one or other of the free sections as required, from one or other of the safety tanks 258. These means are, for example, an arrangement comprising a network of pipes, solenoid valves and fluid distributors arranged to direct the inert fluid as required.

Each purge line 262 is equipped with a non-return valve 264 which allows the passage of a fluid in the purge line 262 of the distribution system 260 towards the associated feed line 206, and towards the associated free section 206a as required, and which prevents the passage of a fluid from the feed line 206, and from the free section 206a as required, towards the distribution system 260.

Each free section 206a is equipped with at least one sensor 266 arranged to detect a leak of hydrogen gas in the free section 206a, regardless of whether the leak occurs in the inner wall or in the outer wall. Each sensor 266 is, for example, a sensor housed between the two walls and capable of detecting hydrogen gas or a variation of pressure.

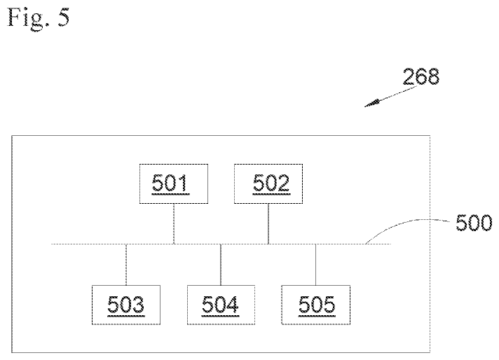

The supply system 200 also comprises a control unit 268, an embodiment of which is shown in FIG. 5.

The control unit 268 is designed to receive information relating to the detection or non-detection of a leak from each sensor 266. If no information relating to a leak is received, the control unit 268 causes the activation of the second means, the opening of each first solenoid shut off valve 220 and each second solenoid shut off valve 212, and the closure of each third solenoid valve 252 and the distribution system 260, so that the inert fluid does not flow. If information relating to a leak in a free section 206a is received, the control unit 268 causes the stopping of the second means corresponding to the free section 206a where the leak has been detected, the closure of the first solenoid shut off valve 220 and the second solenoid shut off valve 212 corresponding to the free section 206a where the leak has been detected, the opening of the third solenoid valve 252 corresponding to the free section 206a where the leak has been detected and the distribution system 260, so that the inert fluid flows towards the free section 206a where the leak has been detected,

The control unit 268 comprises the following, linked by a communication bus 500: a processor or CPU (Central Processing Unit) 501; a random access memory (RAM) 502; a read-only memory (ROM) 503, such as a flash memory; a data storage device such as a hard disc drive (HDD), or an information storage medium (ISM) reader 504, such as a secure digital (SD) card reader; and at least one communication interface 505 enabling the control unit 268 to communicate with the sensors 266, the distribution system 260 and the various solenoid valves.

The processor 501 is capable of executing instructions loaded into the RAM 502 from the ROM 503, from an external memory (not shown), from a storage medium such as an SD card, or from a communication network (not shown). When the control unit 268 is switched on, the processor 501 can read instructions from the RAM 502 and execute them. These instructions form a computer program that causes the processor 501 to implement the behaviors, steps and algorithms described here.

Some or all of the modular architecture and the behaviors, steps and algorithms described here may thus be implemented in software form by the execution of a set of instructions by a programmable machine such as a DSP (Digital Signal Processor) or a microprocessor, or may be implemented in hardware form by a dedicated machine or component (or “chip”) or a dedicated set of components (or “chipset”) such as an FPGA (Field-Programmable Gate Array) or an ASIC (Application-Specific Integrated Circuit). The control unit 268 therefore comprises electronic circuitry arranged and configured to implement the behaviors, steps and algorithms described here.

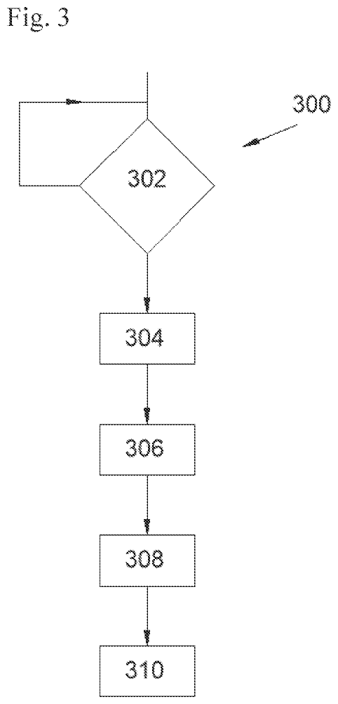

FIG. 3 shows a flow diagram of a purge method 300 implemented in the context of the use of the supply system 200 according to the invention. The purge method 300 comprises, starting from a situation where the control unit 268 causes the activation of the second means, the opening of each first solenoid shut off valve 220 and each second solenoid shut off valve 212, and the closure of each third solenoid valve 252 and the distribution system 260, so that the inert fluid does not flow:
a waiting step 302, in which the control unit 268 waits for information from at least one of the sensors 266 informing it of the detection of a leak in a free section 106a,
if such information is not received, a looping step in which the process loops back to the waiting step 302,
if such information is received, a stopping step 304 in which the control unit 268 causes the stopping of the second means, in this case the pump 210, corresponding to the free section 106a where a leak has been detected, in order to stop the supply of hydrogen gas to the free section 106a,
a closing step 306, in which the control unit 268 causes the closure of the first solenoid shut off valve 220 and the second solenoid shut off valve 212 corresponding to the free section 106a where a leak has been detected, in order to isolate the free section 106a,
an opening step 308, in which the control unit 268 causes the opening of the third solenoid valve 252 corresponding to the free section 106a where a leak has been detected, in order to channel the hydrogen gas remaining in the free section 106a towards the outside, and
a command step 310, in which the control unit 268 commands the distribution system 260 so as to channel the inert fluid from a safety tank 258 towards the free section 106a where a leak has been detected through the associated purge line 262, in order to purge the free section 106a of the hydrogen gas that it contains towards the outside.

With such a method, the hydrogen gas is purged from the free section 106a as soon as a leak is detected there, and it is replaced with an inert fluid.

According to an alternative embodiment, the method comprises, by way of replacement for the closing step 306 and the opening step 308, that is to say, between the stopping step 304 and the command step 310:
a first closing step in which the control unit 268 causes the closure of the second solenoid shut off valve 212 corresponding to the free section 106a where a leak has been detected,
an opening step in which the control unit 268 causes the opening of the third solenoid valve 252 corresponding to the free section 106a where a leak has been detected, and
a second closing step in which the control unit 268 causes the closure of the first solenoid shut off valve 220 corresponding to the free section 106a where a leak has been detected.

With such a method, the free section 206a is not entirely isolated before the opening of the branch line 250, thus avoiding risks of excess pressure.

The systems and devices described herein may include a controller or a computing device, such as control unit 268, comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems for detecting skew in a wing slat of an aircraft described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising a supply system, comprising:
a hydrogen gas tank,
at least one recipient device configured to consume hydrogen gas,
for each recipient device, a double-walled feed line which fluidly connects the hydrogen gas tank and the recipient device,
for each feed line and upstream of the recipient device, a first enclosure, through which the feed line passes in a sealed manner, and in which a heating system, configured to heat the hydrogen gas, is installed on the feed line,
for each feed line, a first solenoid shut off valve mounted on the feed line upstream of the heating system and installed in the first enclosure,
for each feed line and downstream of the hydrogen gas tank, a second enclosure, through which the feed line passes in a sealed manner, and in which a drive system, configured to capture the hydrogen gas in the hydrogen gas tank and drive the hydrogen gas towards the recipient device, is installed on the feed line,
for each feed line, a second solenoid shut off valve, mounted on the feed line downstream of the drive system and installed in the second enclosure, where a free section of said feed line extends outside the first enclosure and the second enclosure, between the first solenoid shut off valve and the second solenoid shut off valve,
for each first enclosure, a supplementary evacuation pipe, a branch line fluidly connected between the feed line and the supplementary evacuation pipe which opens to the outside of the aircraft, and a third solenoid valve mounted on the branch line,
at least one safety tank containing a pressurized inert fluid,
for each free section, a purge line fluidly connected to a corresponding feed line downstream of the second solenoid shut off valve,
a distribution system fluidly connected between said at least one safety tank and each purge line, and comprising an arrangement configured to direct the inert fluid towards the feed line from the safety tank,
for each purge line, a non-return valve mounted on said purge line, to allow passage of a fluid from the distribution system towards the feed line and to prevent passage of a fluid from the feed line towards the distribution system,
for each free section, at least one sensor arranged to detect a leak of hydrogen gas in said free section,
a control unit configured to receive information from each sensor relating to a detection or non-detection of a leak, so that, when no information relating to a leak is received, it causes an activation of the drive system, the opening of each first solenoid shut off valve and each second solenoid shut off valve, and a closure of each third solenoid valve and the distribution system so that the inert fluid does not flow, and so that, when information relating to a leak in a free section is received, it causes the stopping of the drive system corresponding to the free section, a closure of the first solenoid shut off valve and of the second solenoid shut off valve corresponding to the free section, and the opening of the third solenoid valve and the distribution system, so that the inert fluid flows towards the free section.

2. The aircraft according to claim 1, wherein the purge line is fluidly connected to the free section.

3. The aircraft according to claim 1, wherein the branch line is fluidly connected to the free section.

4. The aircraft according to claim 1,
further comprising, for each first enclosure, an evacuation pipe which has one end opening into the first enclosure and a second end opening to the outside, and
wherein the associated supplementary evacuation pipe is fluidly connected to the evacuation pipe.

5. A purge method implemented in an aircraft according to claim 1, wherein the purge method comprises, starting from a situation in which the control unit causes the activation of the drive system, the opening of each first solenoid shut off valve and each second solenoid shut off valve, and the closure of each third solenoid valve and the distribution system so that the inert fluid does not flow:
a waiting step, in which the control unit waits for information from at least one of the sensors informing the control unit of the detection of a leak in a free section,
if such information is not received, a looping step in which the process loops back to the waiting step,
if such information is received, a stopping step in which the control unit causes the stopping of the drive system corresponding to the free section where a leak has been detected,
a closing step in which the control unit causes the closure of the first solenoid shut off valve and the second solenoid shut off valve corresponding to the free section where a leak has been detected,
an opening step in which the control unit causes the opening of the third solenoid valve corresponding to the free section where a leak has been detected, and
a commanding step in which the control unit commands the distribution system so as to feed the inert fluid from a safety tank towards the free section where a leak has been detected.

6. The purge method according to claim 5, further comprising, between the stopping step and the commanding step:
a first closing step in which the control unit causes the closure of the second solenoid shut off valve corresponding to the free section where a leak has been detected,
an opening step in which the control unit causes the opening of the third solenoid valve corresponding to the free section where a leak has been detected, and
a second closing step in which the control unit causes the closure of the first solenoid shut off valve corresponding to the free section where a leak has been detected.
